(19) United States
(12) Patent Application Publication
(10) Pub. No.: US 2023/0286640 A1
(43) Pub. Date: Sep. 14, 2023

(54) ACOUSTIC ABSORBER FOR A GAS TURBINE ENGINE

(71) Applicant: General Electric Company, Schenectady, NY (US)

(72) Inventors: Krishna Kumar G, Bengaluru (IN); Vishnu Vardhan Venkata Tatiparthi, Bengaluru (IN); Vasanth Kumar Balaramudu, Bengaluru (IN)

(21) Appl. No.: 17/838,532

(22) Filed: Jun. 13, 2022

(30) Foreign Application Priority Data
Mar. 10, 2022 (IN) 202211013012

(51) Int. Cl. B64C 1/40

(52) U.S. Cl. CPC B64C 1/40

(57) ABSTRACT

An acoustic absorber for a gas turbine engine includes a back sheet, a face sheet spaced apart from the back sheet and defining a plurality of perforations, and a core layer positioned between the back sheet and the face sheet and comprising a plurality of cells. The core layer comprises an outer wall extending between the back sheet and the face sheet to define an outer boundary of at least one cell of the plurality of cells and an inner wall positioned within the outer boundary to divide the at least one cell of the plurality of cells into an outer damping volume and an inner damping volume, the inner damping volume being at least partially surrounded by the outer damping volume.

### PRIORITY INFORMATION

The present application claims priority to Indian Provisional Patent Application No. 202211013012 filed on Mar. 10, 2022.

### FIELD

The present disclosure relates to gas turbine engines, or more particularly, to acoustic absorbers for use in gas turbine engines.

### BACKGROUND

Aircraft engine noise is a significant problem in high population areas and noise-controlled environments. For example, noise generated by aircraft engines during takeoff and landing is a matter of public concern in most parts of the world. Because of the adverse impact noise has on the environment, many countries have imposed strict noise emission standards on aircraft. In the United States, the Federal Aviation Administration has imposed strict noise emission standards that place stringent operating restrictions on aircraft that are currently in use. These restrictions range from financial penalties and schedule restrictions to an outright ban on the use of the aircraft. An effective and efficient method of noise attenuation is necessary since these restrictions severely curtail the useful life of certain types of aircraft that airlines are currently using.

Aircraft in use today commonly employ a turbofan engine. Turbofan engines draw air into the front of a nacelle duct by way of a fan and push the same air out the back at a higher velocity. The fan is a source of noise since the fan blades pushing through the air cause noise. Once past the fan, the air is split into two paths, the fan duct and the core duct. Downstream of the fan, the flow is swirling because of the spinning fan. This swirl causes loss of momentum before the air exits the nozzle so it is straightened out with stators. These stators are a large source of noise as the wakes of air from fan flow against the stators. Nonuniformities and nonlinearities result in many higher frequency tones being produced. These tones are often associated with the piercing sound generated by some engines. Fan/stator interaction creates more than specific tones. The unsteadiness in the fan flow (turbulence) interacts with the stators to create broadband noise. This is often heard as a rumbling sound. The air passing through the core duct is further compressed through compressor stages. The compressed air is mixed with fuel and burned. Combustion is another source of noise. The hot, high-pressure combusted air is sent into a turbine. Since the turbine tends to look and act like a set of alternating rotors and stators, this is another source of noise. The core duct and the fan duct flows are exhausted into the air outside the back of the aircraft. The interaction of jet exhausts with the surrounding air generates broadband noise.

Known techniques for reducing aircraft engine noise include noise-absorbing acoustic liners or damper structures that line the aircraft engine nacelle and surrounding engine areas. Although damper structures may be utilized to mitigate certain noises, conventional damper structures are generally limited to a single frequency of attenuation. Such limitations may create challenges or complexities at the engine in attempt to attenuate noises generated during operation.

Accordingly, improved acoustic absorbers for use in gas turbine engines would be useful.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a partial perspective view of an acoustic absorber that may be used with the exemplary gas turbine engine of FIG. 1 according to exemplary embodiments of the present subject matter.

FIG. 3 is a perspective view of a single cell of a core layer of an acoustic absorber according to exemplary embodiments of the present subject matter.

FIG. 4 is a perspective view of a single cell of a core layer of an acoustic absorber according to exemplary embodiments of the present subject matter.

FIG. 5 is a schematic, top view of a portion of a core layer of an acoustic absorber according to exemplary embodiments of the present subject matter.

FIG. 6 is a schematic, top view of a portion of a core layer of an acoustic absorber according to exemplary embodiments of the present subject matter.

FIG. 7 is a schematic, top view of a portion of a core layer of an acoustic absorber according to exemplary embodiments of the present subject matter.

FIG. 8 is a schematic, top view of a portion of a core layer of an acoustic absorber according to exemplary embodiments of the present subject matter.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As used herein, the terms “first” and “second” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the disclosure, not limitation of the disclosure. In fact, it will be apparent to those skilled in the art that various modifications and variations can be made in the present disclosure without departing from the scope of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

The present disclosure is generally related to improved acoustic absorbers or other sound damping structures for use in gas turbine engines. In this regard, as noted above, gas turbine engines may generate significant noise during operation. For example, in the case of a turbofan engine, the fan can generate noise as fan blades push through the air. In addition, swirling air from the fan is straightened out with stators, resulting in noise as the wakes of air from fan flow slap against the stators. Air may then pass through the core engine duct, where it is further compressed through compressor stages. More noise is generated by the combustor, where the compressed air is mixed with fuel and burned. The hot, high-pressure combusted air is sent into a turbine, where a set of alternating rotors and stators generate still more noise. The core duct and the fan duct flows are exhausted into the air outside the back of the aircraft, wherein the interaction of jet exhausts with the surrounding air generates broadband noise. Each portion of the engine and each interaction with flowing air may generate noise at a different frequency or range of frequencies, each of which may be undesirable if not attenuated. It may be desirable to reduce such engine noise, e.g., to meet noise emission standards.

Known techniques for reducing aircraft engine noise include noise-absorbing acoustic liners or damper structures that line the aircraft engine nacelle and surrounding engine areas. Although damper structures may be utilized to mitigate certain noises, conventional damper structures are generally limited to a single frequency of attenuation. Such limitations may create challenges or complexities at the engine in attempt to attenuate various noises generated by the engine. As such, there is a need for an acoustic liner or damper structure that may reduce or attenuate noise generated by a gas turbine engine at multiple frequencies.

Aspects of the present subject matter are generally directed to improved acoustic absorbers for use in gas turbine engines. Specifically, exemplary absorbers may reduce or attenuate noise generated by gas turbine engines at multiple targeted frequencies. For example, this noise attenuation may be achieved by using novel noise damping geometries that include shape-in-shape, multiple degree of freedom constructions that are designed to simultaneously attenuate or reduce noise generated at multiple, distinct frequencies. For example, each cell of a core layer of an acoustic absorber may have one portion targeted at reducing noise generated by the fan, another portion targeted at reducing noise generated by the combustor, another portion targeted at reducing noise generated at the exhaust, etc.

In addition, aspects of the present subject matter are directed to novel constructions of acoustic absorbers that utilize various shapes inside another shape having similar/dissimilar sizes or patterns and in a multitude of combinations. These constructions facilitate flexibility in packaging of optimal odd shapes, complex internal shapes, and additional degrees of freedom for optimizing noise attenuation at multiple desired frequencies.

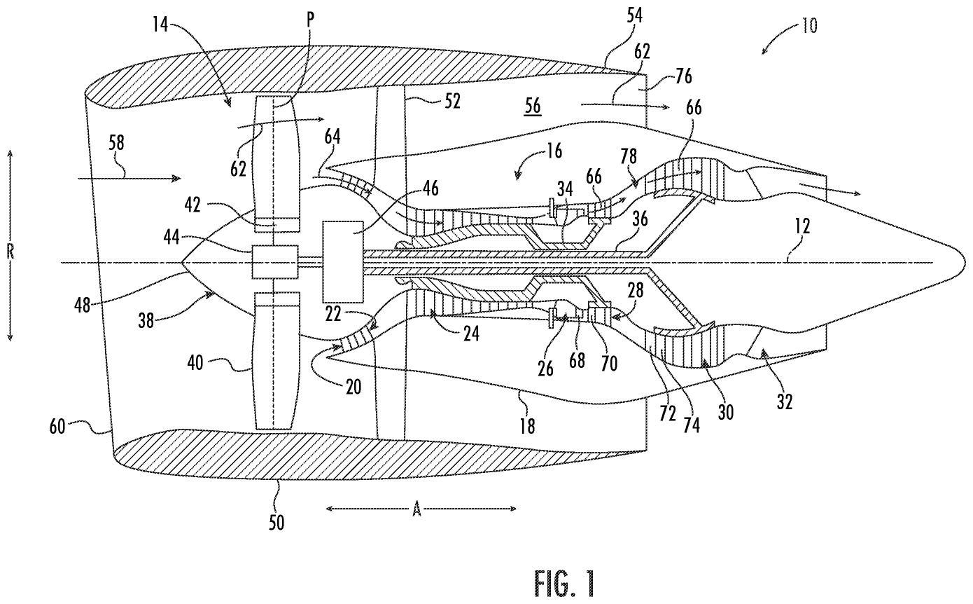

Referring now to the drawings, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline or central axis 12 provided for reference) and a radial direction R. In general, the turbofan engine 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustor or combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22.

For the embodiment depicted, the fan section 14 includes a variable pitch fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable actuation member 44 configured to collectively vary the pitch of the fan blades 40 in unison. The fan blades 40, disk 42, and actuation member 44 are together rotatable about the longitudinal centerline 12 by LP shaft 36 across a power gear box 46. The power gear box 46 includes a plurality of gears for stepping down the rotational speed of the LP shaft 36 to a more efficient rotational fan speed.

Referring still to the exemplary embodiment of FIG. 1, the disk 42 is covered by a rotatable front hub 48 aerodynamically contoured to promote an airflow through the plurality of fan blades 40. Additionally, the exemplary fan section 14 includes an annular fan casing or outer nacelle 50 that circumferentially surrounds the fan 38 and/or at least a portion of the core turbine engine 16. It should be appreciated that the nacelle 50 may be configured to be supported relative to the core turbine engine 16 by a plurality of circumferentially-spaced outlet guide vanes 52. Moreover, a downstream section 54 of the nacelle 50 may extend over an outer portion of the core turbine engine 16 so as to define a bypass airflow passage 56 therebetween.

During operation of the turbofan engine 10, a volume of air 58 enters the turbofan engine 10 through an associated inlet 60 of the nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft or spool 34, thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft or spool 36, thus causing the LP shaft or spool 36 to rotate, thereby supporting operation of the LP compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the turbofan 10, also providing propulsive thrust. The HP turbine 28, the LP turbine 30, and the jet exhaust nozzle section 32 at least partially define a hot gas path 78 for routing the combustion gases 66 through the core turbine engine 16.

It should be appreciated that the exemplary turbofan engine 10 depicted in FIG. 1 is by way of example only and that in other exemplary embodiments, turbofan 10 may have any other suitable configuration. For example, it should be appreciated that in other exemplary embodiments, turbofan engine 10 may instead be configured as any other suitable turbine engine, such as a turboprop engine, turbojet engine, internal combustion engine, etc.

As explained above, gas turbine engines, such as turbofan engine 10, generate significant noise during operation. The frequency and sound intensity or volume of the noise may depend in part on the source of the noise, the engine operating conditions, the construction of the engine, etc. Conventional acoustic absorbers fail to meet the noise attenuation needs desired from modern engines, and the present inventors have developed novel acoustic liners, absorbers, and other sound damping structures that facilitate improved attenuation at desired frequencies. The versatility of construction of such acoustic absorbers allows for target design of the structure and noise attenuating performance. Aspects of the present subject matter are directed to these improved acoustic absorbers.

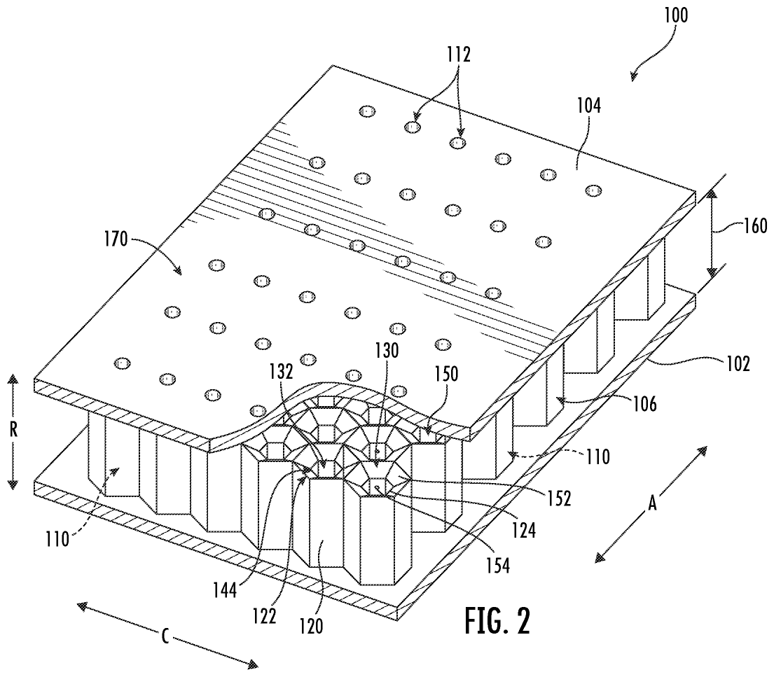

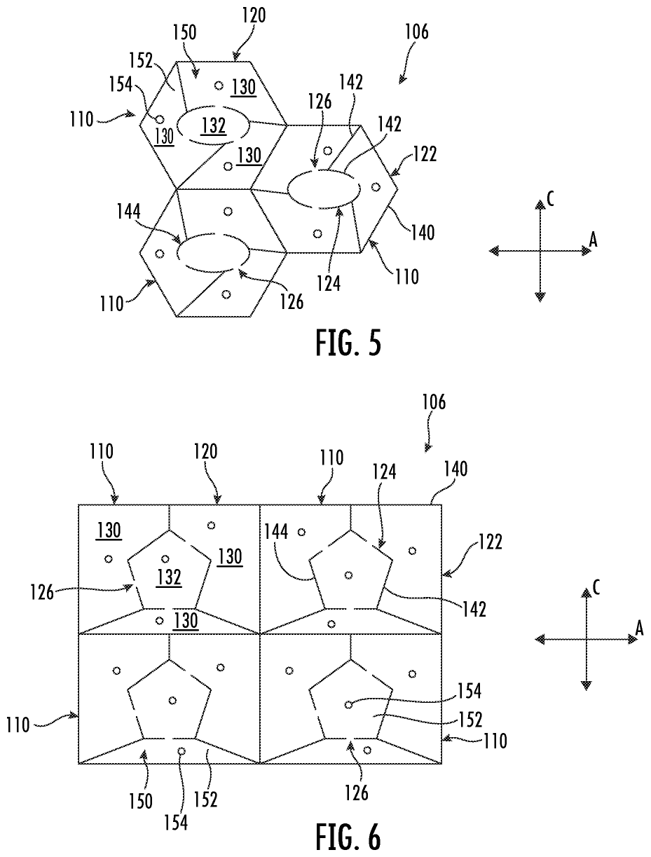

Specifically, referring now generally to FIGS. 2 through 8, an acoustic absorber 100 that may be used within a gas turbine engine, such as turbofan engine 10 of FIG. 1, will be described according to exemplary embodiments. Although an acoustic absorber is described herein as being used in turbofan engine 10, it should be appreciated that this specific application is used only for purposes of facilitating discussion of aspects of the present subject matter. For example, acoustic absorber 100 may be used in any other suitable engine, at any other suitable location within the engine, and may be tuned for attenuating any suitable frequencies. Indeed, aspects of the present subject matter may be further applied to any other suitable technology where sound attenuation at one or more frequencies is desirable.

Referring now specifically to FIG. 2, acoustic absorber 100 may generally include a back sheet 102, a face sheet 104 spaced apart from back sheet 102, and a core layer 106 positioned between back sheet 102 and face sheet 104. Each of these features of acoustic absorber 100 will be described below according to exemplary embodiments. However, it should be appreciated that the acoustic absorber 100 described herein is only exemplary and that variations and modifications may be made to one or more of these features without departing from the scope of the present subject matter.

According to exemplary embodiments, when acoustic absorber 100 is installed in turbofan engine 10 of FIG. 1 (e.g., such as on the walls of the outer casing 18 or nacelle 50), acoustic absorber 100 may generally define an axial direction A and a radial direction R that correspond to the same directions from the turbofan engine 10. Accordingly, like directional orientations may be used in FIGS. 2 through 8. In addition, turbofan engine 10 and acoustic absorber 100 may define a circumferential direction C, e.g., extending around the axial direction A.

According to exemplary embodiments of the present subject matter, back sheet 102 is a substantially solid or imperforate panel that is positioned on a non-flow side of acoustic absorber 100. In this regard, according to exemplary embodiments, back sheet 102 is the portion of acoustic absorber 100 that is attached to a structure or surface of turbofan engine 10. It should be appreciated that the shape, geometry, profile, or contour of acoustic absorber 100 and back sheet 102 may vary depending on the surface to which acoustic absorber 100 is attached. In this regard, acoustic absorber 100 may be used within turbofan engine 10 with negligible effects on the flow dynamics therein. Exemplary positioning of acoustic absorber 100 is described below in more detail according to exemplary embodiments.

In general, back sheet 102 may be mechanically coupled to an inner surface of fan casing 50 (FIG. 1), e.g., the surface of fan casing 50 that defines bypass airflow passage 56. Alternatively, as described in more detail below, back sheet 102 may be attached to the outer casing 18, e.g., within hot gas path 78 (FIG. 1). It should be appreciated that back sheet 102 may be secured using any suitable mechanical fastener, such as screws, rivets, clamping mechanisms, etc. In addition, or alternatively, back sheet 102 may be mounted using any suitable adhesive or other material. According to alternative embodiments, back sheet 102 may also be fastened to turbofan engine 10 using any suitable form of material joining, such as welding, brazing, etc. Other means for attaching acoustic absorber 100 are possible and within scope the present subject matter.

Referring still to FIG. 2, core layer 106 is positioned between back sheet 102 and face sheet 104, e.g., in a space defined there between. In general, core layer 106 comprises a plurality of cells (e.g., identified herein generally by reference numeral 110). Cells 110 are generally sized, shaped, positioned, and fluidly coupled in a manner that facilitates improved noise attenuation at multiple frequencies. Although exemplary cell structures are described herein, it should be appreciated that variations and modifications may be made while remaining within scope the present subject matter.

As illustrated, face sheet 104 may generally define a plurality of perforations 112 that extend through the material or construction of face sheet 104 such that at least one perforation 112 is in fluid communication with each of the plurality of cells 110. In this manner, fluid may flow into cells 110 through perforations 112 such that these cells 110 may act as Helmholtz resonators or may otherwise dampen or attenuate the noise generated at various portions of turbofan engine 10 and at specific targeted frequencies, as described in more detail below. According to the illustrated embodiment, face sheet 104 may define a single perforation 112 for each of the plurality of cells 110. By contrast, according to alternative embodiments, face sheet 104 may define any other suitable number, size, position, and configuration of perforations 112. For example, face sheet 104 could define a porous or mesh structure, or any other structure that includes holes/apertures to permit a desired amount of fluid flow through face sheet 104.

According to the illustrated embodiment, each cell 110 may generally include an outer wall 120 that extends between back sheet 102 and face sheet 104 to define an outer boundary 122 of cell 110. In this regard, outer wall 120 may be a solid wall that does not provide fluid communication with adjacent cells 110. When positioned between back sheet 102 and face sheet 104, outer walls 120 generally define an enclosed volume of cell 110. In this regard, each cell 110 may be fluidly isolated from other cells 110 within core layer 106 except through perforations 112 defined in face sheet 104.

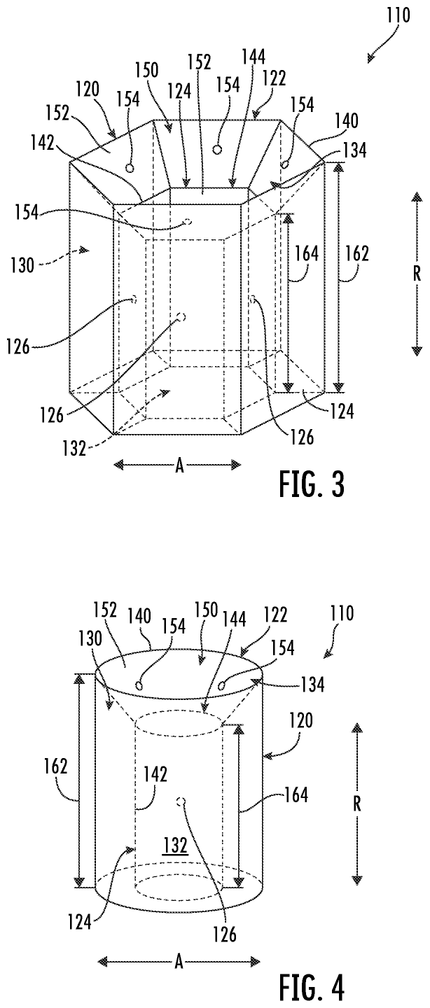

As best shown in FIGS. 3 through 8, core layer 106 may further include one or more inner walls 124 that are positioned within outer boundary 122 of the cell 110 and which divide the internal volume of cell 110 into a plurality of smaller volumes. In general, as used herein, the term “inner walls” is generally intended refer to walls that are entirely contained within outer boundary 122, e.g., such that inner walls 124 at most contact outer walls 120 at their edges. Similar to outer walls 120, inner walls 124 may generally extend parallel to outer walls 120 or perpendicular to back sheet 102. According to alternative embodiments, inner walls 124 may be angled relative to outer walls 120 and/or one or more of back sheet 102 and face sheet 104. In addition, both outer walls 120 and inner walls 124 may be straight, curved, curvilinear, serpentine, or any other suitable shape or profile.

As illustrated, outer walls 120 extend the entire distance from the face sheet 104 to back sheet 102 at an angle that is substantially normal or perpendicular to face sheet 104. However, it should be appreciated that according to alternative embodiments, outer wall 120 and inner walls 124 may extend any other suitable angle. For example, back sheet 102 and/or face sheet 104 may be non-linear or may conform to the surface where acoustic absorber 100 is attached. According to such embodiments, core layer 106 may define an angle relative to back sheet 102 and/or face sheet 104 that is not normal, e.g., may vary between plus or minus 10°, plus or minus 20°, plus or minus 30°, etc. Thus, outer walls 120 and/or inner walls 124 may be angled relative to back sheet 102 and/or face sheet 104 such that they are normal or are not normal depending on the application. Moreover, it should be appreciated that although outer walls 120 and/or inner walls 124 are illustrated herein as being parallel, these structures may be non-parallel according to alternative embodiments. Indeed, outer walls 120 and/or inner walls 124 may have any suitable shapes, sizes, profiles, geometries, etc.

Whereas outer walls 120 are generally solid to prevent flow communication between adjacent cells 110, one or more of inner walls 124 may define apertures 126 that provide fluid communication between the various internal volumes formed by inner walls 124. The number, size, position, and orientation of apertures 126 may vary depending on the application to achieve the desired resonance of a particular volume or to adjust the sound attenuating frequencies or impedances of cells 110 or portions thereof. For example, inner walls 124 could define a porous or mesh structure, a plurality of apertures, or any other structure that permits a desired amount of fluid flow through inner walls 124.

In general, inner walls 124 may divide cells 110 into one or more outer damping volumes (e.g., identified generally by reference numeral 130) and one or more inner damping volumes (e.g., identified generally by reference numeral 132). In general, outer damping volumes 130 may generally refer to those portions of cells 110 that are bounded on at least one side by an outer wall 120, whereas inner damping volumes 132 may generally refer to those portions of cells 110 and that are bounded entirely by inner walls 124. According to exemplary embodiments, inner damping volumes 132 are at least partially surrounded by one or more outer damping volumes 130. For example, according to an exemplary embodiment, inner damping volume 132 is fully enclosed by outer damping volume 130, back sheet 102, and face sheet 104.

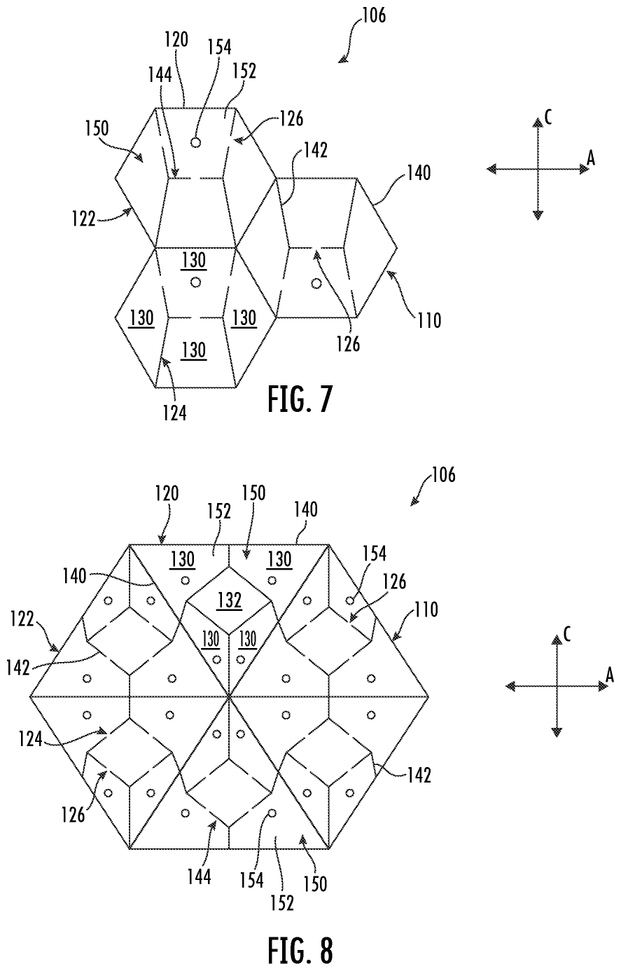

According to exemplary embodiments, each cell 110 may define both outer damping volumes 130 and inner damping volumes 132, e.g., as illustrated in FIGS. 3-6 and 8. By contrast, as illustrated for example in FIG. 7, cells 110 may alternatively define only outer damping volumes 130. Each outer damping volume 130 and inner damping volume 132 may be the same or similar to other volumes within a given cell 110. By contrast, according to alternative embodiments, some or all of outer damping volumes 130 and/or inner damping volumes 132 may be different than each other, e.g., such that they are directed to damping different frequencies than other portions of cell 110. Other configurations are possible and within the scope present subject matter.

For example, although outer damping volumes 130 and inner damping volumes 132 are described herein, it should be appreciated that according to alternative embodiments, one or more additional internal walls may be included to define yet another auxiliary damping volume 134 (see FIGS. 3 and 4) that is at least partially surrounded by inner damping volume 132 and/or outer damping volume 130. For example, FIG. 3 illustrates a single inner damping volume 132 surrounded by six outer damping volumes 130. In addition, auxiliary damping volume 134 is positioned above inner damping volume 132 and outer damping volumes 132 such that air flows into auxiliary damping volume 134 prior to being distributed to inner damping volume 132 and outer damping volumes 132. However, it should be appreciated that each cell 110 may define additional volumes that are similar to or different from outer damping volumes 130 and inner damping volume 132. For example, an additional auxiliary damping volume may be positioned entirely within inner damping volume 132. It should be appreciated that any suitable combination of damping volumes may be included within each cell 110, e.g., to target specific frequencies for attenuation, etc.

Referring now for example to FIG. 3, outer wall 120 may generally include a plurality of outer wall segments 140 that are joined together to form outer boundary 122. In general, outer boundary 122 (e.g., or cell 110 in general) may generally have a polygonal cross-section taken parallel to face sheet 104. Similarly, inner wall 124 may include a plurality of inner wall segments 142 that are connected to define an inner boundary 144. Inner boundary 144 may similarly define an inner polygonal cross-section taken parallel to face sheet 104. According to the embodiment illustrated in FIG. 3, the polygonal cross-section of outer boundary 122 may be the same as the polygonal cross-section of inner boundary 144, e.g., a hexagon. By contrast, FIG. 4 illustrates outer boundary 122 and inner boundary 144 as having circular cross-sections. According to still other embodiments, outer boundary 122 and/or inner boundary 144 may have any other suitable cross-sectional size and geometry. For example, according to exemplary embodiments, the inner polygonal cross-section is of a same or higher order than the outer polygonal cross-section. In this regard, the order of the polygonal cross-section may generally refer to the number of edges or sides of that polygon (e.g., a hexagon has six sides and is thus of higher order than a pentagon, which has five sides).

As best illustrated for example in FIGS. 3 and 4, cells may further define an inlet plenum 150 that is generally positioned adjacent face sheet 104 for receiving the flow of fluid through perforations 112. From inlet plenum 150, the flow of fluid may be distributed among the outer damping volumes 130 and the inner damping volumes 132 through one or more internal perforations (e.g., such as aperture 126 defined within inner walls 124). According to exemplary embodiments, inlet plenum 150 may be open to one or more of inner damping volumes 132 and/or outer damping volumes 130. By contrast, as illustrated, inlet plenum 150 may be defined by one or more plenum walls 152 that are positioned on top of each of outer damping volumes 130 and inner damping volumes 132.

Specifically, referring for example to FIG. 3, inlet plenum 150 is defined by an inner surface of face sheet 104 (not illustrated in FIG. 3), six angled plenum walls 152 that extend at an angle relative to outer wall 120 down to the tops of inner walls 124 such that they sit on top of outer damping volumes 130, and a base plenum wall 152 that sits on top of inner damping volume 132. Similar to inner walls 124, plenum walls 152 may define one or more apertures 154 to provide fluid communication between inlet plenum 150 and at least one of outer damping volumes 130 or inner damping volume 132. Once again, it should be appreciated that the size, position, and geometry of apertures 154 may vary to achieve the desired flow characteristics and resonant frequencies of each outer damping volume 130 and inner damping volume 132. For example, plenum walls 152 could define a porous or mesh structure, a plurality of apertures, or any other structure that permits a desired amount of fluid flow through plenum walls 152.

According to exemplary embodiments of the present subject matter, core layer 106 may generally define a layer height 160 as illustrated in FIG. 2 that is measured between back sheet 102 and face sheet 104. Specifically, layer height 160 may be measured as the shortest distance between the inner surfaces of back sheet 102 and face sheet 104, e.g., to a direction normal to face sheet 104. According to exemplary embodiments, layer height 160 may vary along an axial direction A of turbofan engine 10 or along any other suitable dimension of acoustic absorber 100. For example, by varying layer height 160 along the axial direction A, face sheet 104 may define a desirable contour or profile for the corresponding flow path. In addition, it should be appreciated that the layer height 160 or the total height of acoustic absorber 100 may vary along a radial direction R and/or a circumferential direction C of turbofan engine 10.

Referring again to FIG. 3, outer wall 120 may generally define an outer wall height 162 that is measured along the same direction as layer height 160, e.g., along the length of outer wall 120. Similarly, inner wall 124 may define an inner wall height 164. According to exemplary embodiments, outer wall height 162 is substantially identical or equal to layer height 160, e.g., such that outer wall 120 extends the entire distance between back sheet 102 and face sheet 104. In addition, as illustrated, inner wall height 164 may be equal to or less than layer height 160, e.g., to accommodate inlet plenum 150. Specifically, according to the illustrated embodiment, inner wall height 164 may be between about 50% and 90% of outer wall height 162, between about 60% and 80% of wall height 162, or about 70% of outer wall height 162.

Notably, some or all of the dimensions and features of core layer 106 as described above may be varied to adjust the noise response of each cell 110. In this regard, for example, outer damping volume 130 may be tuned to a first attenuating frequency and inner damping volume 132 may be tuned to a second attenuating frequency that is different than the first attenuating frequency. In addition, one or more other portions of cell 110 may be tuned to still another attenuating frequency. For example, each outer damping volume 130 may be tuned to attenuate one specific frequency, each inner damping volume 130 may be tuned to attenuate another specific frequency, and any other damping volumes (e.g., formed from any combination of inner walls 124 and outer walls 120) may attenuate still another specific frequency. As used herein, a cell (or a portion thereof) is considered tuned to a particular frequency if the size, shape, and geometry are designed to dampen noise and vibrations at that particular frequency. Likewise, a cell is considered tuned to multiple particular frequencies if the size, shape, and geometry of the inner and outer damping volumes 130, 132 (or other volumes) defined therein are designed to dampen noise and vibrations at multiple frequencies, wherein the frequencies can differ between the multiple inner and outer damping volumes 130, 132 (or other volumes). Indeed, each cell 110 may include any suitable number of internal volumes, each of which may be tuned to attenuate a target frequency that may be same as or different than other volumes within the same cell 110. By monitoring the sounds generated by a gas turbine engine during operation, acoustic absorber 100 may be specifically designed to attenuate one or more frequencies of noise generated by that engine.

For example, as explained above, turbofan engine 10 may include a low pressure turbine 30. Low pressure turbine 30 may generate noise during operation at a particular frequency and sound intensity. According to exemplary embodiments, core layer 106 and cells 110 may be designed such that outer damping volume 130 and the corresponding first attenuating frequency correspond to the primary frequency generated by low pressure turbine 30 during operation. In this regard, acoustic absorber 100 may dampen or reduce the noises generated by low pressure turbine 30. Simultaneously, for example, core layer 106 and cells 110 may be designed such that inner damping volume 132 and the corresponding second attenuating frequency correspond to the primary frequency generated by another section of turbofan engine 10, such as combustion section 26. It should be appreciated that each region within a cell 110 of core layer 106 may be designed to attenuate any noise generated from any particular region within turbofan engine 10.

Referring again to FIG. 1, the acoustic absorber 100 may be positioned at one or more portions of the turbofan engine 10 to provide acoustic attenuation across multiple frequencies. As provided above, the target frequency of acoustic attenuation may vary based on the design of acoustic absorber 100, core layer 106, cells 110, outer damping volumes 130, inner damping volumes 132, etc. The target frequencies of acoustic attenuation may be selected based on a variety of parameters, e.g., such as operating conditions, engine condition (e.g., wear, deterioration, damage, etc.), or environmental parameters (e.g., physical properties of the fluid, such as density, temperature, pressure, flow rate, acceleration, rate of change, etc.). The acoustic absorber 100 provided herein may allow certain benefits over conventional acoustic liners typically having layered configurations of plates or openings. The acoustic absorber 100 provided herein may be particularly suitable for portions of turbofan engine 10 that generate troublesome noise, such as the combustion section 26, the turbines 28, 30, and jet exhaust nozzle section 32. In certain embodiments, the acoustic absorber 100 is a single unitary or monolithic component that may allow for multiple target frequency attenuation, as explained below.

As such, in certain embodiments, the acoustic absorber 100 is positioned at the casing 18, nacelle 50, or at any other location surrounding a fluid flow path such as described with respect to FIG. 1. A fluid contact side 170 of the acoustic absorber 100 (e.g., an outer face of face sheet 104) is positioned at the fluid flow path of the turbofan engine 10. In various embodiments, the acoustic absorber 100 is positioned at the combustion section 26. The acoustic absorber 100 including the plurality of cells 110 that may be configured to attenuate sound at various target frequencies or frequency ranges.

The target frequency ranges may correspond various engine operating conditions. For example, in one embodiment, acoustic absorber 100 may include cells 110 that target low frequency acoustic waves (50-250 Hz) such as those that occur during engine startup and/or during a low power to idle operating condition. Acoustic absorber 100 may also include cells 110 that target higher frequency waves (250-1000 Hz), such as may correspond to greater engine operating conditions. Acoustic absorber 100 may also include cells 110 that target higher frequency waves (750-1000 Hz), such as may correspond to high power or takeoff operation. However, it should be appreciated that the ranges may be adjusted according to desired engine configurations, operating conditions, or target frequencies.

In various embodiments, the acoustic absorber 100 is positioned at the outer casing 18 at the combustion section 26. The fluid flow path may be a diffuser cavity or a pressure plenum surrounding a combustion chamber. In a particular embodiment, the fluid flow path is an outer flow passage surrounding the combustion chamber. The acoustic absorber 100 may be positioned or integrated into the outer casing to allow the outer casing to attenuate undesired noises or pressure oscillations occurring from the combustion section 26, such as due to the combustion process as described herein.

In still various other embodiments, the acoustic absorber 100 is positioned at the outer casing 18 surrounding the core turbine engine 16. In a particular embodiment, the acoustic absorber 100 is positioned at the outer casing 18 surrounding one or more turbines 28, 30 and/or the jet exhaust nozzle section 32. The acoustic absorber 100 positioned at or downstream of the turbines 28, 30 such as at the jet exhaust nozzle section 32, may allow for noise attenuation of jet combustion gases exiting the turbofan engine 10. In still particular embodiments, the monolithic acoustic absorber 100 positioned at the jet exhaust nozzle section 32 may allow for multiple frequency acoustic attenuation. The acoustic absorber 100 may also be positioned at the fan casing or nacelle 50 to attenuate noise or pressure oscillations upstream or downstream of the fan blades 40. In some embodiments, the fluid flow path is the inlet 60 upstream of the fan blades 40. In another embodiment, the fluid flow path is the bypass flow passage 56 downstream of fan blades 40. Other positions of acoustic absorber 100 are possible and within the scope of the present subject matter.

The acoustic absorber 100 described herein may be manufactured or formed using any suitable process, such as an additive manufacturing process, such as a 3-D printing process. The use of such a process may allow the acoustic absorber 100 to be formed integrally, as a single unitary or monolithic component. In particular, the additive manufacturing process may allow such component to be integrally formed and include a variety of features not possible when using prior manufacturing methods, such as the plurality of cells 110 tuned to attenuate multiple frequencies.

As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although one applicable process includes adding material to form successive layers, one skilled in the art will appreciate that the methods and structures disclosed herein may be practiced with any additive manufacturing technique or manufacturing technology. For example, embodiments of the present disclosure may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets, laser jets, and binder jets, Stereolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

The additive manufacturing processes described herein may be used for forming the acoustic absorber 100 using any suitable material. For example, the material may be plastic, metal, ceramic, polymer, epoxy, photopolymer resin, or any other suitable material that may be in solid, liquid, powder, sheet material, wire, or any other suitable form or combinations thereof. The plastic, metal, ceramic, polymer, epoxy, photopolymer resin, or other suitable material may be included with the acoustic absorber 100 positioned at the nacelle 50, such as described herein. In particular embodiments, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, and nickel or cobalt based superalloys (e.g., those available under the name Inconel® available from Special Metals Corporation). These materials are examples of materials suitable for use in the additive manufacturing processes described herein, and may be generally referred to as “additive materials.” Such metals described herein may be particularly included with embodiments of the acoustic absorber 100 positioned at the combustion section 26, the turbines 28, 30, or jet exhaust nozzle section 32 (FIG. 1), such as described herein. However, it should be appreciated that materials may be utilized in accordance with their intended operating conditions. For example, ramjet or scramjet applications may utilize materials suitable for relatively hot or high-stress conditions at inlet portions of the engine, such as upstream of the inlet 60 (FIG. 1).

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Notably, in exemplary embodiments, several features of the acoustic absorber 100 described herein were previously not possible due to manufacturing restraints, such as the pluralities of cells 110 providing varying attenuating frequencies. However, the present disclosure has advantageously utilized advances in additive manufacturing techniques to develop exemplary embodiments of such components generally in accordance with the present disclosure. While the present disclosure is not limited to the use of additive manufacturing to form these components generally, additive manufacturing does provide a variety of manufacturing advantages, including ease of manufacturing, reduced cost, greater accuracy, etc.

Further aspects are provided by the subject matter of the following clauses:

An acoustic absorber for a gas turbine engine comprising a back sheet, a face sheet spaced apart from the back sheet and defining a plurality of perforations, and a core layer positioned between the back sheet and the face sheet and comprising a plurality of cells, wherein the core layer comprises an outer wall extending between the back sheet and the face sheet to define an outer boundary of at least one cell of the plurality of cells, and an inner wall positioned within the outer boundary to divide the at least one cell of the plurality of cells into an outer damping volume and an inner damping volume, the inner damping volume being at least partially surrounded by the outer damping volume.

The acoustic absorber of any preceding clause, wherein the outer wall comprises a plurality of outer wall segments connected to define the outer boundary, wherein the outer boundary defines an outer polygonal cross-section taken parallel to the face sheet.

The acoustic absorber of any preceding clause, wherein the inner wall comprises a plurality of inner wall segments connected to define an inner boundary, wherein the inner boundary defines an inner polygonal cross-section taken parallel to the face sheet.

The acoustic absorber of any preceding clause, wherein the inner polygonal cross-section is of a same or higher order than the outer polygonal cross-section.

The acoustic absorber of any preceding clause, wherein the inner damping volume is fully enclosed by outer damping volume, the back sheet, and the face sheet.

The acoustic absorber of any preceding clause, wherein each of the inner wall and the outer wall extend normal to the face sheet.

The acoustic absorber of any preceding clause, wherein the inner wall defines at least one aperture.

The acoustic absorber of any preceding clause, wherein the plurality of perforations defined in the face sheet comprises a single perforation for each of the plurality of cells.

The acoustic absorber of any preceding clause, wherein the core layer defines a layer height measured between the back sheet and the face sheet, and wherein the layer height varies along an axial direction of the gas turbine engine.

The acoustic absorber of any preceding clause, wherein the core layer defines a layer height measured between the back sheet and the face sheet, and wherein the layer height varies along a circumferential direction of the gas turbine engine.

The acoustic absorber of any preceding clause, wherein the core layer defines a layer height measured between the back sheet and the face sheet and the outer wall defines an outer wall height that is equal to the layer height.

The acoustic absorber of any preceding clause, wherein the core layer defines a layer height measured between the back sheet and the face sheet and the inner wall defines an inner wall height that is equal to or less than the layer height.

The acoustic absorber of any preceding clause, wherein the inner wall divides the at least one cell of the plurality of cells to further define an auxiliary damping volume, the auxiliary damping volume being at least partially surrounded by at least one of the inner damping volume or the outer damping volume.

The acoustic absorber of any preceding clause, wherein the outer damping volume is tuned to a first attenuating frequency and the inner damping volume is tuned to a second attenuating frequency different that the first attenuating frequency.

The acoustic absorber of any preceding clause, wherein the gas turbine engine comprises a low pressure turbine and the first attenuating frequency corresponds to a primary frequency generated by the low pressure turbine during operation.

The acoustic absorber of any preceding clause, wherein the gas turbine engine comprises a combustor and the second attenuating frequency corresponds to a primary frequency generated by the combustor during operation.

The acoustic absorber of any preceding clause, wherein the gas turbine engine further comprises a casing surrounding a fluid flow path, wherein the acoustic absorber is positioned at the casing such that the face sheet is positioned at the fluid flow path.

The acoustic absorber of any preceding clause, wherein the fluid flow path is a fan inlet upstream of a fan blade, is a bypass fluid flow passage downstream of a fan blade, is a combustion chamber, is a pressure plenum surrounding the combustion chamber, or is downstream of a turbine.

The acoustic absorber of any preceding clause, wherein the back sheet, the face sheet, and the core layer are integrally formed as a single monolithic component.

The acoustic absorber of any preceding clause wherein the outer wall and the inner wall extend at an angle that is not normal to the face sheet.

The acoustic absorber of any preceding clause, further comprising a plurality of internal walls to define at least one of multiple outer damping volumes, multiple inner damping volumes, or multiple auxiliary damping volumes.

The acoustic absorber of any preceding clause, wherein the multiple outer damping volumes are tuned to different attenuating frequencies.

The acoustic absorber of any preceding clause, wherein the multiple inner damping volumes are tuned to different attenuating frequencies.

A gas turbine engine comprising a casing surrounding a fluid flow path, and an acoustic absorber positioned on the casing within the fluid flow path, wherein the acoustic absorber comprises a back sheet, a face sheet spaced apart from the back sheet and defining a plurality of perforations, and a core layer positioned between the back sheet and the face sheet and comprising a plurality of cells, wherein the core layer comprises an outer wall extending between the back sheet and the face sheet to define an outer boundary of at least one cell of the plurality of cells, and an inner wall positioned within the outer boundary to divide the at least one cell of the plurality of cells into an outer damping volume and an inner damping volume, the inner damping volume being at least partially surrounded by the outer damping volume.

The gas turbine engine of any preceding clause, wherein the outer wall comprises a plurality of outer wall segments connected to define the outer boundary, wherein the outer boundary defines an outer polygonal cross-section taken parallel to the face sheet.

The gas turbine engine of any preceding clause, wherein the inner wall comprises a plurality of inner wall segments connected to define an inner boundary, wherein the inner boundary defines an inner polygonal cross-section taken parallel to the face sheet.

The gas turbine engine of any preceding clause, wherein the inner polygonal cross-section is of a same or higher order than the outer polygonal cross-section.

The gas turbine engine of any preceding clause, wherein the inner damping volume is fully enclosed by outer damping volume, the back sheet, and the face sheet.

The gas turbine engine of any preceding clause, wherein each of the inner wall and the outer wall extend normal to the face sheet.

The gas turbine engine of any preceding clause, wherein the inner wall defines at least one aperture.

The gas turbine engine of any preceding clause, wherein the plurality of perforations defined in the face sheet comprises a single perforation for each of the plurality of cells.

The gas turbine engine of any preceding clause, wherein the core layer defines a layer height measured between the back sheet and the face sheet, and wherein the layer height varies along an axial direction of the gas turbine engine.

The gas turbine engine of any preceding clause, wherein the core layer defines a layer height measured between the back sheet and the face sheet, and wherein the layer height varies along a circumferential direction of the gas turbine engine.

The gas turbine engine of any preceding clause, wherein the core layer defines a layer height measured between the back sheet and the face sheet and the outer wall defines an outer wall height that is equal to the layer height.

The gas turbine engine of any preceding clause, wherein the core layer defines a layer height measured between the back sheet and the face sheet and the inner wall defines an inner wall height that is equal to or less than the layer height.

The gas turbine engine of any preceding clause, wherein the inner wall divides the at least one cell of the plurality of cells to further define an auxiliary damping volume, the auxiliary damping volume being at least partially surrounded by at least one of the inner damping volume or the outer damping volume.

The gas turbine engine of any preceding clause, wherein the outer damping volume is tuned to a first attenuating frequency and the inner damping volume is tuned to a second attenuating frequency different that the first attenuating frequency.

The gas turbine engine of any preceding clause, wherein the gas turbine engine comprises a low pressure turbine and the first attenuating frequency corresponds to a primary frequency generated by the low pressure turbine during operation.

The gas turbine engine of any preceding clause, wherein the gas turbine engine comprises a combustor and the second attenuating frequency corresponds to a primary frequency generated by the combustor during operation.

The gas turbine engine of any preceding clause, wherein the gas turbine engine further comprises a casing surrounding a fluid flow path, wherein the acoustic absorber is positioned at the casing such that the face sheet is positioned at the fluid flow path.

The gas turbine engine of any preceding clause, wherein the fluid flow path is a fan inlet upstream of a fan blade, is a bypass fluid flow passage downstream of a fan blade, is a combustion chamber, is a pressure plenum surrounding the combustion chamber, or is downstream of a turbine.

The gas turbine engine of any preceding clause, wherein the back sheet, the face sheet, and the core layer are integrally formed as a single monolithic component.

The gas turbine engine of any preceding clause wherein the outer wall and the inner wall extend at an angle that is not normal to the face sheet.

The gas turbine engine of any preceding clause, further comprising a plurality of internal walls to define at least one of multiple outer damping volumes, multiple inner damping volumes, or multiple auxiliary damping volumes.

The gas turbine engine of any preceding clause, wherein the multiple outer damping volumes are tuned to different attenuating frequencies.

The gas turbine engine of any preceding clause, wherein the multiple inner damping volumes are tuned to different attenuating frequencies.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. An acoustic absorber for a gas turbine engine, the acoustic absorber comprising:
a back sheet;
a face sheet spaced apart from the back sheet and defining a plurality of perforations; and
a core layer positioned between the back sheet and the face sheet and comprising a plurality of cells, wherein the core layer comprises:
an outer wall extending between the back sheet and the face sheet to define an outer boundary of at least one cell of the plurality of cells; and
an inner wall positioned within the outer boundary to divide the at least one cell of the plurality of cells into an outer damping volume and an inner damping volume, the inner damping volume being at least partially surrounded by the outer damping volume.

2. The acoustic absorber of claim 1, wherein the outer wall comprises a plurality of outer wall segments connected to define the outer boundary, wherein the outer boundary defines an outer polygonal cross-section taken parallel to the face sheet.

3. The acoustic absorber of claim 2, wherein the inner wall comprises a plurality of inner wall segments connected to define an inner boundary, wherein the inner boundary defines an inner polygonal cross-section taken parallel to the face sheet.

4. The acoustic absorber of claim 3, wherein the inner polygonal cross-section is of a same or higher order than the outer polygonal cross-section.

5. The acoustic absorber of claim 1, wherein the inner damping volume is fully enclosed by outer damping volume, the back sheet, and the face sheet.

6. The acoustic absorber of claim 1, wherein each of the inner wall and the outer wall extend normal to the face sheet.

7. The acoustic absorber of claim 1, wherein the inner wall defines at least one aperture.

8. The acoustic absorber of claim 1, wherein the plurality of perforations defined in the face sheet comprises a single perforation for each of the plurality of cells.

9. The acoustic absorber of claim 1, wherein the core layer defines a layer height measured between the back sheet and the face sheet, and wherein the layer height varies along an axial direction of the gas turbine engine.

10. The acoustic absorber of claim 1, wherein the core layer defines a layer height measured between the back sheet and the face sheet, and wherein the layer height varies along a circumferential direction of the gas turbine engine.

11. The acoustic absorber of claim 1, wherein the core layer defines a layer height measured between the back sheet and the face sheet and the outer wall defines an outer wall height that is equal to the layer height.

12. The acoustic absorber of claim 1, wherein the core layer defines a layer height measured between the back sheet and the face sheet and the inner wall defines an inner wall height that is equal to or less than the layer height.

13. The acoustic absorber of claim 1, wherein the inner wall divides the at least one cell of the plurality of cells to further define an auxiliary damping volume, the auxiliary damping volume being at least partially surrounded by at least one of the inner damping volume or the outer damping volume.

14. The acoustic absorber of claim 1, wherein the outer damping volume is tuned to a first attenuating frequency and the inner damping volume is tuned to a second attenuating frequency different that the first attenuating frequency.

15. The acoustic absorber of claim 14, wherein the gas turbine engine comprises a low pressure turbine and the first attenuating frequency corresponds to a primary frequency generated by the low pressure turbine during operation.

16. The acoustic absorber of claim 14, wherein the gas turbine engine comprises a combustor and the second attenuating frequency corresponds to a primary frequency generated by the combustor during operation.

17. The acoustic absorber of claim 1, wherein the gas turbine engine further comprises a casing surrounding a fluid flow path, wherein the acoustic absorber is positioned at the casing such that the face sheet is positioned at the fluid flow path.

18. The acoustic absorber of claim 17, wherein the fluid flow path is a fan inlet upstream of a fan blade, is a bypass fluid flow passage downstream of a fan blade, is a combustion chamber, is a pressure plenum surrounding the combustion chamber, or is downstream of a turbine.

19. The acoustic absorber of claim 1, wherein the back sheet, the face sheet, and the core layer are integrally formed as a single monolithic component.

20. A gas turbine engine, comprising:
a casing surrounding a fluid flow path; and
an acoustic absorber positioned on the casing within the fluid flow path, wherein the acoustic absorber comprises:
a back sheet;
a face sheet spaced apart from the back sheet and defining a plurality of perforations; and
a core layer positioned between the back sheet and the face sheet and comprising a plurality of cells, wherein the core layer comprises:
an outer wall extending between the back sheet and the face sheet to define an outer boundary of at least one cell of the plurality of cells; and
an inner wall positioned within the outer boundary to divide the at least one cell of the plurality of cells into an outer damping volume and an inner damping volume, the inner damping volume being at least partially surrounded by the outer damping volume.
